(19) United States
(12) Patent Application Publication
(10) Pub. No.: US 2025/0088882 A1
(43) Pub. Date: Mar. 13, 2025

(54) METHOD AND APPARATUS FOR DATA USAGE REPORT IN A BEARER CONTEXT MODIFICATION REQUEST

(71) Applicant: Rakuten Symphony, Inc., Tokyo (JP)

(72) Inventors: Rohan IYER, Bangalore, Karnataka (IN); Venkatarao MALEMPATI, Bangalore, Karnataka (IN); Praveen Kumar ALUR SHIVASWAMY, Bangalore, Karnataka (IN); Venkateswara Reddy PERAM, Bangalore, Karnataka (IN); Venkatgiri TURVIHAL, Bangalore, Karnataka (IN)

(73) Assignee: Rakuten Symphony, Inc., Tokyo (JP)

(21) Appl. No.: 18/266,727

(22) PCT Filed: Apr. 21, 2023
(86) PCT No.: PCT/US2023/019325

§ 371 Date: Jun. 12, 2023

(51) Int. Cl. H04W 24/10

(52) U.S. Cl. CPC H04W 24/10

(57) ABSTRACT

A first network node, comprises a memory configured to store computer program code that includes first transmitting code configured to cause a processor to transmit, to a second network node, a bearer context modification request that includes an information element requesting a data usage report. The program code further includes first receiving code configured to cause the processor to receive, from the second network node in response to the information element included in the bearer context modification request, a bearer context modification response and a data usage report. The program code further includes forwarding code configured to cause at least one of said at least one processor to the data usage report to a third network node.

### TECHNICAL FIELD

The present disclosure relates generally to communication systems, and more particularly to methods and apparatuses for a data usage report in a bearder context modification request.

### BACKGROUND

Multi-Radio Dual Connectivity (MR-DC) is a generalization of the Intra-E-UTRA Dual Connectivity (DC), where a multiple Rx/Tx capable UE may be configured to utilize resources provided by two different nodes connected via a non-ideal backhaul, one providing New Radio (NR) access and the other one providing either E-UTRA or NR access. One node acts as the master node (MN) and the other as the secondary node (SN). The MN and SN are connected via a network interface and at least the MN is connected to the core network.

A purpose of the Secondary Radio Access Technology (RAT) Data Usage Report is to provide information on the used resources of the secondary RAT. The Secondary RAT Usage Report List is an important information element (IE) in SECONDARY RAT DATA USAGE REPORT message that needs to be sent from a gNB to an eNB and to a core network. Within the gNB, a central unit user plane (CUUP) node sends this Data Usage Report List IE, in DATA USAGE REPORT and forwards the same to a centralunit control plane (CUCP), either periodically or during a UE release, which is subsequently forwarded to the eNB. However, currently there is no mechanism for the CUCP to request the CUUP for the Data Usage report.

Improvements are presented herein. These improvements may also be applicable to other multi-access technologies and the telecommunication standards that employ these technologies.

### SUMMARY

The following presents a simplified summary of one or more embodiments of the present disclosure in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments of the present disclosure in a simplified form as a prelude to the more detailed description that is presented later.

According to one or more embodiments, a first network node comprises at least one memory configured to store computer program code, and at least one processor configured to access said at least one memory and operate as instructed by the computer program code. The computer program code includes first transmitting code configured to cause at least one of said at least one processor to transmit, to a second network node, a bearer context modification request that includes an information element requesting a data usage report. The computer program code further includes first receiving code configured to cause at least one of said at least one processor to receive, from the second network node in response to the information element included in the bearer context modification request, a bearer context modification response and a data usage report, the computer program code further includes forwarding code configured to cause at least one of said at least one processor to the data usage report to a third network node.

According to one or more embodiments, a method performed by at least one processor of a first network node comprises transmitting, to a second network node, a bearer context modification request that includes an information element requesting a data usage report. The method further comprises receiving, from the second network node in response to the information element included in the bearer context modification request, a bearer context modification response and a data usage report. The method further comprises forwarding the data usage report to a third network node.

According to one or more embodiments, a non-transitory computer readable medium having instructions stored therein, which when executed by a processor of a first network node cause the processor to execute a method that comprises transmitting, to a second network node, a bearer context modification request that includes an information element requesting a data usage report. The method further comprises receiving, from the second network node in response to the information element included in the bearer context modification request, a bearer context modification response and a data usage report. The method further comprises forwarding the data usage report to a third network node.

Additional embodiments will be set forth in the description that follows and, in part, will be apparent from the description, and/or may be learned by practice of the presented embodiments of the disclosure.

### BRIEF DESCRIPTION OF THE DRAWINGS

The above and other aspects, features, and aspects of embodiments of the disclosure will be apparent from the following description taken in conjunction with the accompanying drawings, in which:

FIG. 1 is a diagram of an example network device in accordance with various embodiments of the present disclosure.

FIG. 2 is a schematic diagram of an example wireless communications system, in accordance with various embodiments of the present disclosure.

FIG. 3 illustrates an example call flow diagram in which a secondary node (SN) sends a secondary radio access technology (RAT) data usage report message to a master node MN, in accordance with various embodiments of the present disclosure.

FIG. 4 illustrates an example call flow diagram in which a SN sends a secondary RAT data usage report to a MN, in accordance with various embodiments of the present disclosure.

FIG. 5 illustrates an example call flow diagram of a bearer context modification procedure, in accordance with various embodiments of the present disclosure.

FIG. 6 illustrates an example call flow diagram of a MN initiated release, in accordance with various embodiments of the present disclosure.

FIG. 7 illustrates an example call flow diagram of a SN initiated release, in accordance with various embodiments of the present disclosure.

FIG. 8 illustrates an example flowchart of a process for requesting and sending a data usage report, in accordance with various embodiments of the present disclosure.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” or similar language means that a particular feature, structure, or characteristic described in connection with the indicated embodiment is included in at least one embodiment of the present solution. Thus, the phrases “in one embodiment”, “in an embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

Embodiments of the present disclosure are directed to including an information element (IE) in a bearer context modification request, where the IE indicates that a data usage report is required. Particularly, the embodiments of the present disclosure enable a gNB central unit control plane (gNB-CU-CP) node to advantageously add an IE to a bearer context modification request, sent to the gNB central unit user plane (gNB-CU-UP) indicating that the secondary RAT data usage report is required

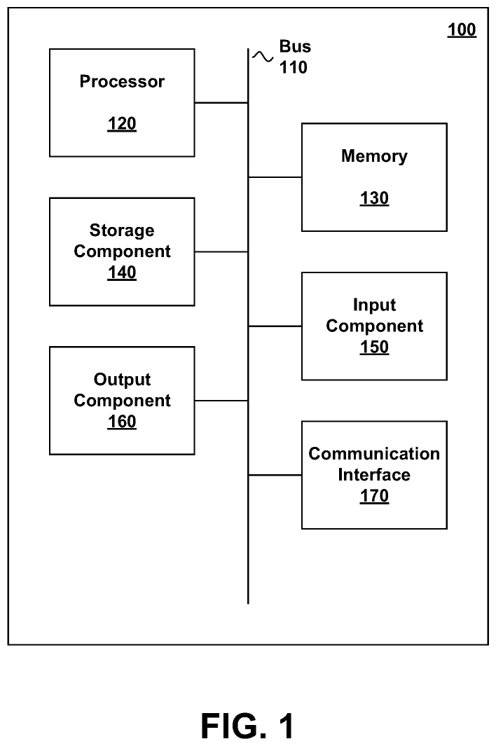

FIG. 1 is diagram of an example device for performing the embodiments of the present disclosure. Device 100 may correspond to any type of known computer, server, or data processing device. For example, the device 100 may comprise a processor, a personal computer (PC), a printed circuit board (PCB) comprising a computing device, a mini-computer, a mainframe computer, a microcomputer, a telephonic computing device, a wired/wireless computing device (e.g., a smartphone, a personal digital assistant (PDA)), a laptop, a tablet, a smart device, or any other similar functioning device.

In some embodiments, as shown in FIG. 1, the device 100 may include a set of components, such as a processor 120, a memory 130, a storage component 140, an input component 150, an output component 160, and a communication interface 170.

The bus 110 may comprise one or more components that permit communication among the set of components of the device 100. For example, the bus 110 may be a communication bus, a cross-over bar, a network, or the like. Although the bus 110 is depicted as a single line in FIG. 1, the bus 110 may be implemented using multiple (two or more) connections between the set of components of device 100. The disclosure is not limited in this regard.

The device 100 may comprise one or more processors, such as the processor 120. The processor 120 may be implemented in hardware, firmware, and/or a combination of hardware and software. For example, the processor 120 may comprise a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), a general purpose single-chip or multi-chip processor, or other programmable logic device, discrete gate or transistor logic, discrete hardware components, or any combination thereof designed to perform the functions described herein. A general purpose processor may be a microprocessor, or any conventional processor, controller, microcontroller, or state machine. The processor 120 also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function.

The processor 120 may control overall operation of the device 100 and/or of the set of components of device 100 (e.g., the memory 130, the storage component 140, the input component 150, the output component 160, the communication interface 170).

The device 100 may further comprise the memory 130. In some embodiments, the memory 130 may comprise a random access memory (RAM), a read only memory (ROM), an electrically erasable programmable ROM (EEPROM), a flash memory, a magnetic memory, an optical memory, and/or another type of dynamic or static storage device. The memory 130 may store information and/or instructions for use (e.g., execution) by the processor 120.

The storage component 140 of device 100 may store information and/or computer-readable instructions and/or code related to the operation and use of the device 100. For example, the storage component 140 may include a hard disk (e.g., a magnetic disk, an optical disk, a magneto-optic disk, and/or a solid state disk), a compact disc (CD), a digital versatile disc (DVD), a universal serial bus (USB) flash drive, a Personal Computer Memory Card International Association (PCMCIA) card, a floppy disk, a cartridge, a magnetic tape, and/or another type of non-transitory computer-readable medium, along with a corresponding drive.

The device 100 may further comprise the input component 150. The input component 150 may include one or more components that permit the device 100 to receive information, such as via user input (e.g., a touch screen, a keyboard, a keypad, a mouse, a stylus, a button, a switch, a microphone, a camera, and the like). Alternatively or additionally, the input component 150 may include a sensor for sensing information (e.g., a global positioning system (GPS) component, an accelerometer, a gyroscope, an actuator, and the like).

The output component 160 of device 100 may include one or more components that may provide output information from the device 100 (e.g., a display, a liquid crystal display (LCD), light-emitting diodes (LEDs), organic light emitting diodes (OLEDs), a haptic feedback device, a speaker, and the like).

The device 100 may further comprise the communication interface 170. The communication interface 170 may include a receiver component, a transmitter component, and/or a transceiver component. The communication interface 170 may enable the device 100 to establish connections and/or transfer communications with other devices (e.g., a server, another device). The communications may be effected via a wired connection, a wireless connection, or a combination of wired and wireless connections. The communication interface 170 may permit the device 100 to receive information from another device and/or provide information to another device. In some embodiments, the communication interface 170 may provide for communications with another device via a network, such as a local area network (LAN), a wide area network (WAN), a metropolitan area network (MAN), a private network, an ad hoc network, an intranet, the Internet, a fiber optic-based network, a cellular network (e.g., a fifth generation (5G) network, a long-term evolution (LTE) network, a third generation (3G) network, a code division multiple access (CDMA) network, and the like), a public land mobile network (PLMN), a telephone network (e.g., the Public Switched Telephone Network (PSTN)), or the like, and/or a combination of these or other types of networks. Alternatively or additionally, the communication interface 170 may provide for communications with another device via a device-to-device (D2D) communication link, such as FlashLinQ, WiMedia, Bluetooth, ZigBee, Wi-Fi, LTE, 5G, and the like. In other embodiments, the communication interface 170 may include an Ethernet interface, an optical interface, a coaxial interface, an infrared interface, a radio frequency (RF) interface, or the like.

The device 100 may perform one or more processes described herein. The device 100 may perform operations based on the processor 120 executing computer-readable instructions and/or code that may be stored by a non-transitory computer-readable medium, such as the memory 130 and/or the storage component 140. A computer-readable medium may refer to a non-transitory memory device. A memory device may include memory space within a single physical storage device and/or memory space spread across multiple physical storage devices.

Computer-readable instructions and/or code may be read into the memory 130 and/or the storage component 140 from another computer-readable medium or from another device via the communication interface 170. The computer-readable instructions and/or code stored in the memory 130 and/or storage component 140, if or when executed by the processor 120, may cause the device 100 to perform one or more processes described herein.

Alternatively or additionally, hardwired circuitry may be used in place of or in combination with software instructions to perform one or more processes described herein. Thus, embodiments described herein are not limited to any specific combination of hardware circuitry and software.

The number and arrangement of components shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Additionally or alternatively, a set of (one or more) components shown in FIG. 1 may perform one or more functions described as being performed by another set of components shown in FIG. 1.

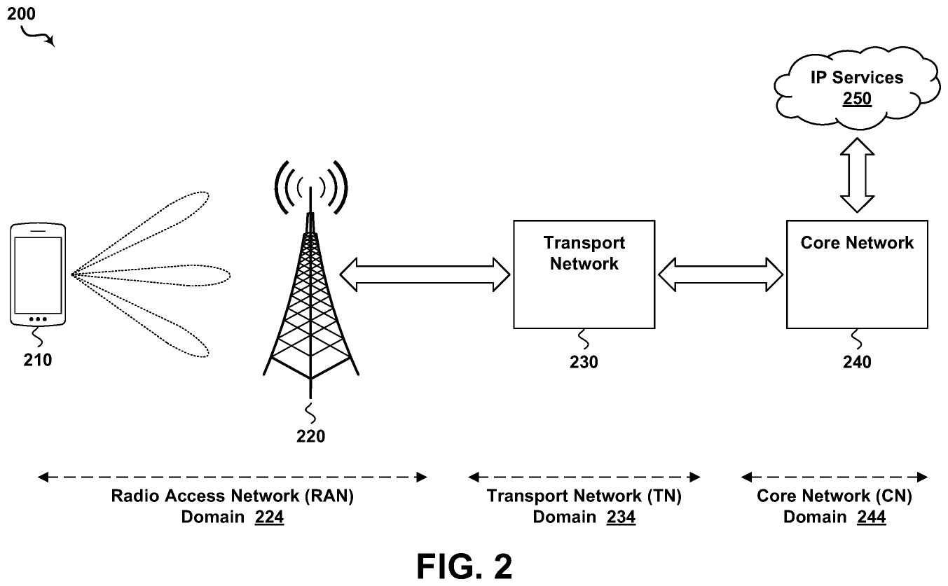

FIG. 2 is a diagram illustrating an example of a wireless communications system, according to various embodiments of the present disclosure. The wireless communications system 200 (which may also be referred to as a wireless wide area network (WWAN)) may include one or more user equipment (UE) 210, one or more base stations 220, at least one transport network 230, and at least one core network 240. The device 100 (FIG. 1) may be incorporated in the UE 210 or the base station 220.

The one or more UEs 210 may access the at least one core network 240 and/or IP services 250 via a connection to the one or more base stations 220 over a RAN domain 224 and through the at least one transport network 230. Examples of UEs 210 may include a cellular phone, a smart phone, a session initiation protocol (SIP) phone, a laptop, a personal digital assistant (PDA), a satellite radio, a global positioning system (GPS), a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similarly functioning device. Some of the one or more UEs 210 may be referred to as Internet-of-Things (IoT) devices (e.g., parking meter, gas pump, toaster, vehicles, heart monitor, etc.). The one or more UEs 210 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile agent, a client, or some other suitable terminology.

The one or more base stations 220 may wirelessly communicate with the one or more UEs 210 over the RAN domain 224. Each base station of the one or more base stations 220 may provide communication coverage to one or more UEs 210 located within a geographic coverage area of that base station 220. In some embodiments, as shown in FIG. 2, the base station 220 may transmit one or more beamformed signals to the one or more UEs 210 in one or more transmit directions. The one or more UEs 210 may receive the beamformed signals from the base station 220 in one or more receive directions. Alternatively or additionally, the one or more UEs 210 may transmit beamformed signals to the base station 220 in one or more transmit directions. The base station 220 may receive the beamformed signals from the one or more UEs 210 in one or more receive directions.

The one or more base stations 220 may include macrocells (e.g., high power cellular base stations) and/or small cells (e.g., low power cellular base stations). The small cells may include femtocells, picocells, and microcells. A base station 220, whether a macrocell or a large cell, may include and/or be referred to as an access point (AP), an evolved (or evolved universal terrestrial radio access network (E-UTRAN)) Node B (eNB), a next-generation Node B (gNB), or any other type of base station known to one of ordinary skill in the art.

The one or more base stations 220 may be configured to interface (e.g., establish connections, transfer data, and the like) with the at least one core network 240 through at least one transport network 230. In addition to other functions, the one or more base stations 220 may perform one or more of the following functions: transfer of data received from the one or more UEs 210 (e.g., uplink data) to the at least one core network 240 via the at least one transport network 230, transfer of data received from the at least one core network 240 (e.g., downlink data) via the at least one transport network 230 to the one or more UEs 210.

The transport network 230 may transfer data (e.g., uplink data, downlink data) and/or signaling between the RAN domain 224 and the CN domain 244. For example, the transport network 230 may provide one or more backhaul links between the one or more base stations 220 and the at least one core network 240. The backhaul links may be wired or wireless.

The core network 240 may be configured to provide one or more services (e.g., enhanced mobile broadband (eMBB), ultra-reliable low-latency communications (URLLC), and massive machine type communications (mMTC), etc.) to the one or more UEs 210 connected to the RAN domain 224 via the TN domain 234. Alternatively or additionally, the core network 240 may serve as an entry point for the IP services 250. The IP services 250 may include the Internet, an intranet, an IP multimedia subsystem (IMS), a streaming service (e.g., video, audio, gaming, etc.), and/or other IP services.

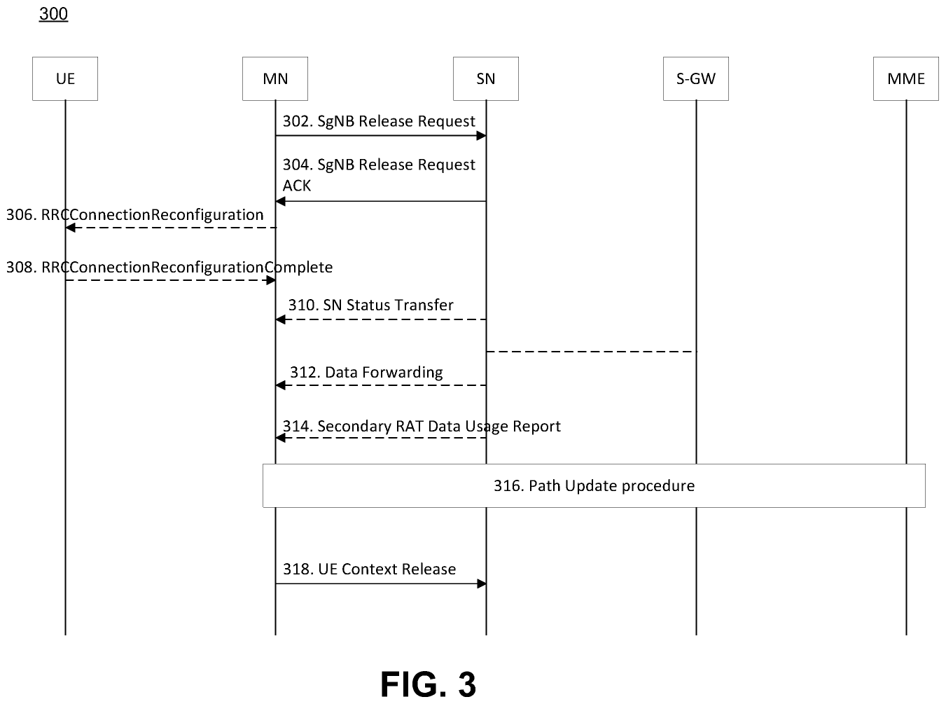

FIG. 3 illustrates an example call flow diagram 300 directed to a master node (MN) initiated release process in which a secondary node (SN) sends a secondary radio access technology (RAT) data usage report message to the MN, in accordance with various embodiments of the present disclosure. As illustrated in FIG. 3, the SN sends the secondary RAT data usage report message to the MN and includes data volumes delivered to and received from the UE over the New Radio (NR) for related E-UTRAN Radio Access Bearers (E-RABs).

In operation 302, the MN sends a SgNB release request to the SN. In operation 304, the SN sends a SGNB release request acknowledge to the MN. In operation 306, the MN sends a RRCConnectionReconfiguration message to the UE. In operation 308, the UE sends a RRCConnectionReconfigurationComplete message to the MN.

In operation 310, the SN sends a SN status transfer to the MN. In operation 312, the SN forwards data received from the S-GW to the MN. Operation 316 corresponds to a path update procedure spanning the MN, SN, S-GW, and mobility management entity (MME). In operation 318, the MN sends a context release message to the SN. In one or more examples, if data forwarding is applied, the order the SN sends the Secondary RAT Data Usage Report message and starts data forwarding with the MN is not defined (e.g., operation 314 may take place before operation 312). For example, the SN does not need to wait for the end of data forwarding to send the Secondary RAT Data Usage Report message.

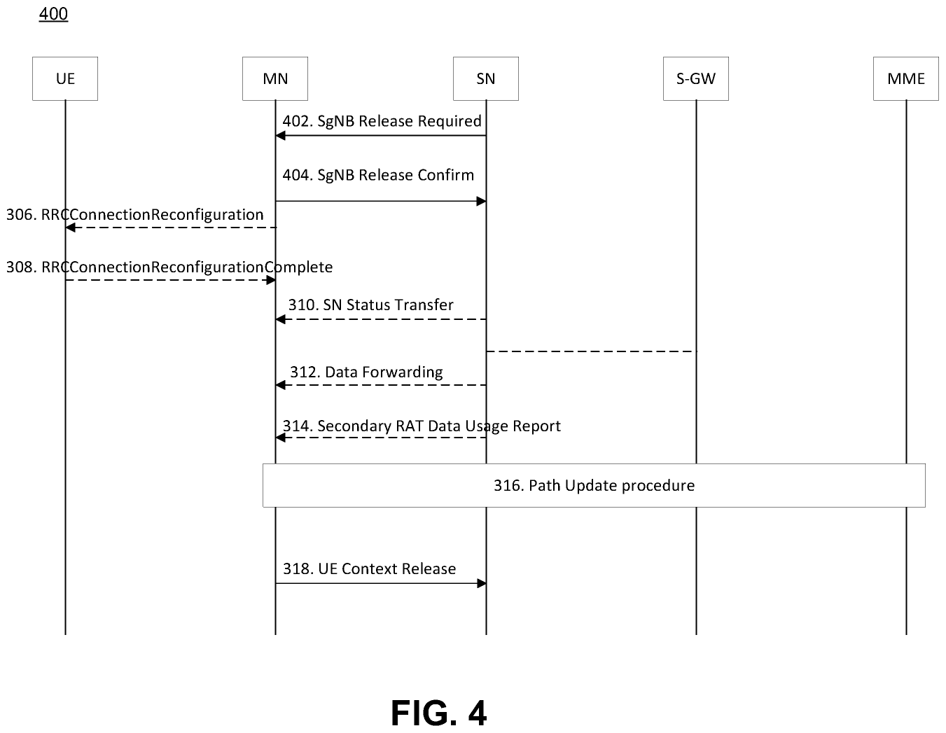

FIG. 4 illustrates another example call flow diagram 400 in which a SN sends a secondary RAT data usage report to a MN, in accordance with various embodiments of the present disclosure. Compared to the call flow diagram 300, which corresponds to an MN initiated release, the call flow diagram 400 corresponds to an SN initiated release. In operation 402, the SN sends a SgNB release required message to the MN. In operation 404, the MN sends a SgNB release confirm message to the SN. The remaining operations 306-318 in FIG. 4 correspond to operations 306-318, respectively, in FIG. 3.

Generally, the data usage report is triggered by gNB-CU-UP. The request for the same needs to be communicated to gNB-CU-UP from gNB-CU-CP as part of the Bearer Context Modification Request message. In the related art, however, there is no explicit indication or IE for gNB-CU-CP to request for the Secondary RAT data usage report. The above mechanisms are currently triggered when in response to SgNB Release Request (MN Initiated Release) or SgNB Release Required (SN Initiated Release), gNB-CU-CP initiates a Bearer Context Modification Request message with either “Data Forwarding Information” IE or “PDCP SN Status” IE. Further, PDCP SN Status IE is used only for AM mode bearers and Data Forwarding Information IE is triggered only when requested by eNB. In the event of the bearer being a UM mode bearer and data forwarding information not requested by eNB, there is no IE in the related art for gNB-CU-CP to request for Secondary RAT data usage report towards gNB-CU-UP over E1 interface.

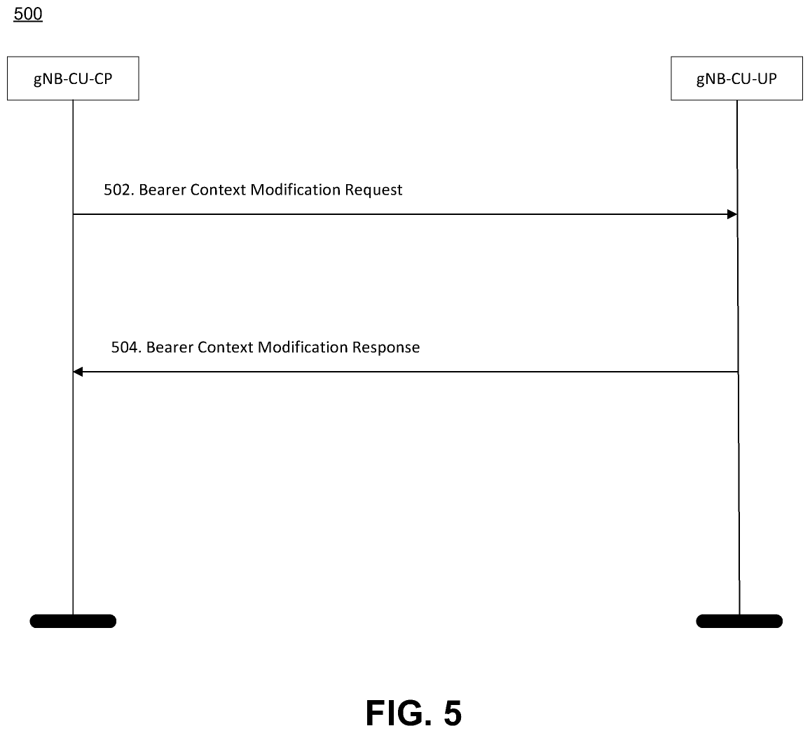

FIG. 5 illustrates an example call flow diagram 500 diagram of a bearer context modification request and response, in accordance with one or more embodiments.

In operation 502, the gNB-CU-CP initiates the procedure by sending a Bearer Context Modification Request to the gNB-CU-UP. The bearer context modification request may be associated with a communication of a UE in the wireless communication network. If the gNB-CU-UP succeeds to modify the bearer context, in operation 504, the gNB-CU-UP replies to the gNB-CU-CP with a Bearer Context Modification Response message.

According to one or more embodiments, the gNB-CU-UP may report to the gNB-CU-CP, in the Bearer Context Modification Response message, the result for all the requested resources in accordance with one of more of the following examples:

### For E-UTRAN:

A list of DRBs which are successfully established may be included in the DRB Setup List IE;
A list of DRBs which failed to be established may be included in the DRB Failed List IE;
A list of DRBs which are successfully modified may be included in the DRB Modified List IE;
A list of DRBs which failed to be modified may be included in the DRB Failed To Modify List IE;

For NG-RAN:
A list of PDU Session Resources which are successfully established may be included in the PDU Session Resource Setup List IE;
A list of PDU Session Resources which failed to be established may be included in the PDU Session Resource Failed List IE;
A list of PDU Session Resources which are successfully modified may be included in the PDU Session Resource Modified List IE;
A list of PDU Session Resources which failed to be modified may be included in the PDU Session Resource Failed To Modify List IE;
For each successfully established or modified PDU Session Resource, a list of DRBs which are successfully established may be included in the DRB Setup List IE;
For each successfully established or modified PDU Session Resource, a list of DRBs which failed to be established may be included in the DRB Failed List IE;
For each successfully modified PDU Session Resource, a list of DRBs which are successfully modified may be included in the DRB Modified List IE;
For each successfully modified PDU Session Resource, a list of DRBs which failed to be modified may be included in the DRB Failed To Modify List IE;
For each successfully established or modified DRB, a list of QoS Flows which are successfully established may be included in the Flow Setup List IE;
For each successfully established or modified DRB, a list of QoS Flows which failed to be established may be included in the Flow Failed List IE.

In one or more examples, when the gNB-CU-UP reports the unsuccessful establishment of a PDU Session Resource, DRB or QoS Flow, the cause value should be precise enough to enable the gNB-CU-CP to know the reason for the unsuccessful establishment.

In one or more examples, if the Security Information IE is contained in the BEARER CONTEXT MODIFICATION REQUEST message, the gNB-CU-UP may update the corresponding information.

In one or more examples, if the UE DL Aggregate Maximum Bit Rate IE is contained in the BEARER CONTEXT MODIFICATION REQUEST message, the gNB-CU-UP may update the corresponding information.

In one or more examples, if the UE DL Maximum Integrity Protected Data Rate IE is contained in the BEARER CONTEXT MODIFICATION REQUEST message, the gNB-CU-UP may update the corresponding information.

In one or more examples, if the Bearer Context Status Change IE is contained in the BEARER CONTEXT MODIFICATION REQUEST message, the gNB-CU-UP may consider the UE RRC state and response accordingly.

In one or more examples, if the Data Forwarding Information Request IE, PDU Session Data Forwarding Information Request IE or the DRB Data Forwarding Information Request IE are included in the BEARER CONTEXT MODIFICATION REQUEST message, the gNB-CU-UP may include the requested forwarding information in the Data Forwarding Information Response IE, PDU Session Data Forwarding Information Response IE or the DRB Data Forwarding Information Response IE in the BEARER CONTEXT MODIFICATION RESPONSE message.

In one or more examples, if the PDU Session Data Forwarding Information IE is included in the BEARER CONTEXT MODIFICATION REQUEST message, the gNB-CU-UP may, if supported, consider that data forwarding is applicable for the indicated QoS flows for the concerned PDU session.

In one or more examples, if the PDCP Configuration IE is contained in the DRB To Modify List IE in the BEARER CONTEXT MODIFICATION REQUEST message, the gNB-CU-UP may update the corresponding information, except for the PDCP SN UL Size IE, the PDCP SN DL Size IE and the RLC mode IE which may be ignored.

In one or more examples, if the E-UTRAN QOS IE is contained in the DRB To Modify List IE in the BEARER CONTEXT MODIFICATION REQUEST message, the gNB-CU-UP may update the corresponding information.

In one or more examples, if the PDCP SN Status Request IE is contained in the DRB To Modify List IE in the BEARER CONTEXT MODIFICATION REQUEST message, the gNB-CU-UP may respond accordingly and include the UL COUNT Value IE and the DL COUNT Value IE in the BEARER CONTEXT MODIFICATION RESPONSE message.

In one or more examples, if the PDCP SN Status Information IE is contained in the DRB To Setup List IE or the DRB To Modify List IE in the BEARER CONTEXT MODIFICATION REQUEST message, the gNB-CU-UP may take it into account and respond accordingly.

In one or more examples, if the DL UP Parameters IE is contained in the DRB To Modify List IE in the BEARER CONTEXT MODIFICATION REQUEST message, the gNB-CU-UP may update the corresponding information.

In one or more examples, if the Cell Group To Add IE or the Cell Group To Modify IE or the Cell Group To Remove IE is contained in the DRB To Modify List IE in the BEARER CONTEXT MODIFICATION REQUEST message, the gNB-CU-UP may add or modify or remove the corresponding cell group.

In one or more examples, if the PDU Session Resource DL Aggregate Maximum Bit Rate IE is contained in the PDU Session Resource To Setup List IE in the BEARER CONTEXT MODIFICATION REQUEST message, the gNB-CU-UP may replace the information in the UE context and use it when enforcing downlink traffic policing for the non GBR QOS flows for the concerned UE.

In one or more examples, if the PDU Session Resource DL Aggregate Maximum Bit Rate IE is contained in the PDU Session Resource To Modify List IE in the BEARER CONTEXT MODIFICATION REQUEST message, the gNB-CU-UP may update the corresponding information.

In one or more embodiments, if the SDAP Configuration IE is contained in the DRB To Modify List IE in the BEARER CONTEXT MODIFICATION REQUEST message, the gNB-CU-UP may update the corresponding information.

In one or more embodiments, if the Flow Mapping Information IE is contained in the DRB To Modify List IE in the BEARER CONTEXT MODIFICATION REQUEST message, the gNB-CU-UP may update the corresponding information.

In one or more embodiments, for each requested DRB, if the PDCP Duplication IE or Additional PDCP duplication Information IE is included in the PDCP Configuration IE contained in the BEARER CONTEXT MODIFICATION REQUEST message, then the gNB-CU-CP may include two or more UP Transport Layer Information IEs in the BEARER CONTEXT MODIFICATION REQUEST message, and the gNB-CU-UP may, if supported, also include two or more UP Transport Layer Information IEs in the BEARER CONTEXT MODIFICATION RESPONSE message to support packet duplication. If only one cell group is included in the Cell Group Information IE for the concerned DRB, then the gNB-CU-UP may consider that the first UP Transport Layer Information IE of these UP Transport Layer Information IEs is for the primary path. If more than one cell group is included in the Cell Group Information IE, the gNB-CU-UP may consider that the number of duplication tunnels for each cell group is indicated by the Number of tunnels IE, and that the first UP Transport Layer Information IE for each cell group is for the primary path or the split secondary path.

In one or more examples, for a certain DRB which was allocated with two or more GTP-U tunnels, if this DRB is modified and given one GTP-U tunnel via the Bearer Context Modification (gNB-CU-CP initiated) procedure (e.g., only one UP Transport Layer Information per Cell Group ID is present in DL UP Parameters IE for the concerned DRB), the gNB-CU-UP may consider that PDCP duplication is deconfigured for this DRB. If this type of Bearer Context Modification (e.g., gNB-CU-CP initiated) procedure occurs, the Duplication Activation IE may not be included for the concerned DRB.

In one or more examples, if the New UL TNL Information Required IE is contained in the BEARER CONTEXT MODIFICATION REQUEST message, the gNB-CU-UP may include the new UP Transport Layer Information in the BEARER CONTEXT MODIFICATION RESPONSE message.

In one or more examples, for each PDU session for which the Security Indication IE is included in the PDU Session Resource To Setup List IE of the BEARER CONTEXT MODIFICATION REQUEST message, and the Integrity Protection Indication IE or Confidentiality Protection Indication IE is set to “preferred”, the gNB-CU-UP may, if supported, perform user plane integrity protection or ciphering, respectively, for the concerned PDU session and may notify whether it performed the user plane integrity protection or ciphering by including the Integrity Protection Result IE or Confidentiality Protection Result IE, respectively, in the PDU Session Resource Setup List IE of the BEARER CONTEXT MODIFICATION RESPONSE message.

In one or more examples, for each PDU session for which the Security Indication IE is included in the PDU Session Resource To Setup List IE of the BEARER CONTEXT MODIFICATION REQUEST message, and the Integrity Protection Indication IE or Confidentiality Protection Indication IE is set to “required”, the gNB-CU-UP may perform user plane integrity protection or ciphering, respectively, for the concerned PDU Session. If the gNB-CU-UP cannot perform the user plane integrity protection or ciphering, gNB-CU-UP may reject the setup of the PDU Session Resources with an appropriate cause value.

In one or more examples, for each PDU session for which the Security Indication IE is included in the PDU Session Resource To Setup List of the BEARER CONTEXT MODIFICATION REQUEST message:
if the Integrity Protection Indication IE is set to “not needed”, the gNB-CU-UP may not perform user plane integrity protection for the concerned PDU session;
if the Confidentiality Protection Indication IE is set to “not needed”, the gNB-CU-UP may not perform user plane ciphering for the concerned PDU session.

In one or more examples, for each PDU Session Resource, if the Network Instance IE is included in the PDU Session Resource To Setup List IE or the PDU Session Resource To Modify List IE in the BEARER CONTEXT MODIFICATION REQUEST message and the Common Network Instance IE is not included, the gNB-CU-UP may, if supported, use it when selecting a transport network resource.

In one or more examples, for each PDU session, if the Common Network Instance IE is included in the PDU Session Resource To Setup List IE or the PDU Session Resource To Modify List IE in the BEARER CONTEXT MODIFICATION REQUEST message, the gNB-CU-UP may, if supported, use it when selecting a transport network resource.

In one or more examples, for each PDU session, if the Redundant NG UL UP Transport Layer Information IE is included in the PDU Session Resource To Setup List IE or the PDU Session Resource To Modify List IE in the BEARER CONTEXT MODIFICATION REQUEST message, the gNB-CU-UP may, if supported, include the Redundant NG DL UP Transport Layer Information IE in the PDU Session Resource Setup List IE or the PDU Session Resource Modified List IE in the BEARER CONTEXT MODIFICATION RESPONSE message.

In one or more examples, if the Redundant Common Network Instance IE is included in the PDU Session Resource To Setup List IE or the PDU Session Resource To Modify List IE in the BEARER CONTEXT MODIFICATION REQUEST message, the gNB-CU-UP may, if supported, use it when selecting a transport network resource for the redundant transmission.

In one or more examples, for each PDU session for which the Redundant QoS Flow Indicator IE is included in QoS Flows Information To Be Setup IE contained in the BEARER CONTEXT MODIFICATION REQUEST message, the gNB-CU-UP may, if supported, store and use it as necessary.

In one or more examples, for each PDU session, if the Redundant QoS Flow Indicator IE is set to false for all QoS flows, the gNB-CU-UP may, if supported, stop the redundant transmission and release the redundant tunnel for the concerned PDU session.

In one or more examples, if the QoS Flow Mapping Indication IE is contained in the QoS Flow QoS Parameters List IE in the BEARER CONTEXT MODIFICATION REQUEST message, the gNB-CU-UP may, if supported, replace any previously received value and take it into account that only the uplink or downlink QoS flow is mapped to the DRB.

In one or more examples, if the Data Discard Required IE is contained in the BEARER CONTEXT MODIFICATION REQUEST message and the value is set to “Required”, the gNB-CU-UP may consider that a RAN Paging Failure occurred for that UE. The gNB-CU-UP may discard the user plane data for that UE and consider that the bearer context is still suspended.

In one or more examples, if UE Inactivity Timer IE or PDU session Inactivity Timer IE or DRB Inactivity Timer IE is contained in BEARER CONTEXT MODIFICATION REQUEST message, the gNB-CU-UP may take it into account when perform inactivity monitoring.

In one or more examples, if the S-NSSAI IE is contained in the PDU Session Resource To Modify List IE in the BEARER CONTEXT MODIFICATION REQUEST message, the gNB-CU-UP may store the corresponding information and replace any existing information.

In one or more examples, if the DRB QOS IE is contained within the DRB To Setup List IE in the BEARER CONTEXT MODIFICATION REQUEST message, the gNB-CU-UP may, if supported, take it into account for each DRB.

In one or more examples, if the DRB QOS IE is contained within the DRB To Modify List IE in the BEARER CONTEXT MODIFICATION REQUEST message, the gNB-CU-UP may, if supported, replace any previously received value and take it into account for each DRB.

In one or more examples, if the gNB-DU-ID IE is contained in the BEARER CONTEXT MODIFICATION REQUEST message, the gNB-CU-UP may store and replace any previous information received.

In one or more examples, if the RAN UE ID IE is contained in the BEARER CONTEXT MODIFICATION REQUEST message, the gNB-CU-UP may store and replace any previous information received.

In one or more examples, if the gNB-CU-UP receives a BEARER CONTEXT MODIFICATION REQUEST message including Activity Notification Level IE and its value does not match the current bearer context, the gNB-CU-UP may ignore the Activity Notification Level IE and also the requested modification of inactivity timer.

In one or more examples, for each successfully established DRB, the gNB-CU-UP may provide, in the respective UL UP Parameters IE of the BEARER CONTEXT MODIFICATION RESPONSE, one UL UP Transport Layer Information Item per cell group entry contained in the respective Cell Group Information IE of the BEARER CONTEXT MODIFICATION REQUEST message.

In one or more examples, if the Old QoS Flow List-UL End Marker expected IE is included in the PDU Session Resource To Modify List IE of the BEARER CONTEXT MODIFICATION REQUEST message for a DRB to be modified, the gNB-CU-UP may consider that the source NG-RAN node has initiated QoS flow re-mapping and has not yet received SDAP end markers. The gNB-CU-UP may consider that the Old QoS Flow List-UL End Marker expected IE only contains UL QoS flow information for QoS flows for which no SDAP end marker has been yet received on the source side.

In one or more examples, for EN-DC, if the Subscriber Profile ID for RAT/Frequency priority IE is included in the BEARER CONTEXT MODIFICATION REQUEST, the gNB-CU-UP may use it to apply specific RRM policies. If the Additional RRM Policy Index IE is included in the BEARER CONTEXT MODIFICATION REQUEST, the gNB-CU-UP may use it to apply specific RRM policies.

In one or more examples, if the Data Usage Report Required IE is included in the BEARER CONTEXT MODIFICATION REQUEST, the gNB-CU-UP may trigger DATA USAGE REPORT message immediately after sending BEARER CONTEXT MODIFICATION RESPONSE.

Table 1, illustrated below, provides a description of contents of a bearer context modification request in accordance with one or more example embodiments. This message may be sent by the gNB-CU-CP to request the gNB-CU-UP to modify a bearer context. The direction may be from the gNB-CU-CP to the gNB-CU-UP.

TABLE 1

| | | | | | | |
|---|---|---|---|---|---|---|
| | | | IE type and | Semantics | | Assigned |
| IE/Group Name | Presence | Range | reference | description | Criticality | Criticality |

| | | | | | |
|---|---|---|---|---|---|
| Message Type | M | 9.3.1.1 | | YES | reject |
| gNB-CU-CP UE | M | 9.3.1.4 | | YES | reject |
| E1AP ID | | | | | |
| gNB-CU-UP UE | M | 9.3.1.5 | | YES | reject |
| E1AP ID | | | | | |
| Security | O | 9.3.1.10 | | YES | reject |
| Information | | | | | |
| UE DL | O | Bit Rate 9.3.1.20 | | YES | reject |
| Aggregate | | | | | |
| Maximum Bit | | | | | |
| Rate | | | | | |
| UE DL | O | Bit Rate 9.3.1.20 | The Bit Rate | YES | reject |
| Maximum | | | is a portion of | | |
| Integrity | | | the UE's | | |
| Protected Data | | | Maximum | | |
| Rate | | | Integrity | | |
| | | | Protected | | |
| | | | Data Rate, | | |
| | | | and is | | |
| | | | enforced by | | |
| | | | the gNB-CU- | | |
| | | | UP node. | | |
| Bearer Context | O | ENUMERATED | Indicates the | YES | reject |
| Status Change | | (Suspend, | status of the | | |
| | | Resume, . . .) | Bearer | | |
| | | | Context | | |
| New UL TNL | O | ENUMERATED | Indicates that | YES | reject |
| Information | | (required, . . .) | new UL TNL | | |
| Required | | | information | | |
| | | | has been | | |
| | | | requested to | | |
| | | | be provided. | | |
| UE Inactivity | O | Inactivity Timer | Included if the | — | — |
| Timer | | 9.3.1.54 | Activity | | |
| | | | Notification | | |
| | | | Level is set to | | |
| | | | UE | | |
| Data Discard | O | ENUMERATED | Indicate to | YES | ignore |
| Required | | (required, . . .) | discard the | | |
| | | | DL user data | | |
| | | | in case of | | |
| | | | RAN paging | | |
| | | | failure. | | |
| CHOICE System | O | | | YES | reject |
| >E-UTRAN | | | | | |
| >>DRB To | O | DRB To Setup | | YES | reject |
| Setup List | | Modification List | | | |
| | | E-UTRAN | | | |
| | | 9.3.3.7 | | | |
| >>DRB To | O | DRB To Modify | | YES | reject |
| Modify List | | List E-UTRAN | | | |
| | | 9.3.3.8 | | | |
| >>DRB To | O | DRB To Remove | | YES | reject |
| Remove List | | List E-UTRAN | | | |
| | | 9.3.3.9 | | | |
| >>Subscriber | O | 9.3.1.69 | | YES | ignore |
| Profile ID for | | | | | |
| RAT/Frequency | | | | | |
| priority | | | | | |
| >>Additional | O | 9.3.1.70 | | YES | ignore |
| RRM Policy | | | | | |
| Index | | | | | |
| >> Data Usage | O | ENUMERATED | Indicate to | YES | ignore |
| Report | | (required, . . .) | trigger Data | | |
| Required | | | Usage Report | | |

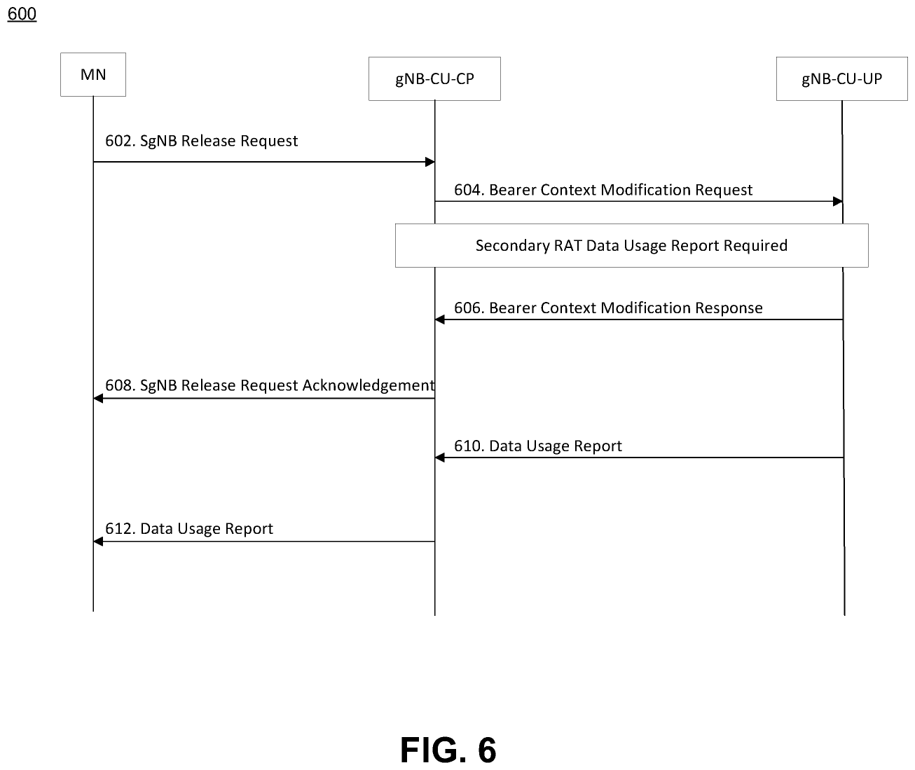

FIG. 6 illustrates an example call flow 600 of a MN initiated release, in accordance with one or more embodiments.

In operation 602, the MN sends a SgNB release request message to the gNB-CU-UP. In operation 604, in response to the SgNB release request message, the gNB-CU-CP sends a bearer context modification request to the gNB-CU-UP. The bearer context modification request message may include the IE that indicates that the secondary RAT data usage report is required. The bearer context modification request may be associated with a communication of a UE in the wireless communication network.

In operation 606, the gNB-CU-UP may send a bearer context modification response to the gNB-CU-UP. In operation 608, the gNB-CU-UP may send a SgNB release request acknowledgement message to the MN. In operation 610, the gNB-CU-UP may send a data usage report to the gNB-CU-UP. In operation 612, the gNB-CU-CP may forward the data usage report to the MN. In one or more embodiments, the data usage report is a secondary RAT data usage report.

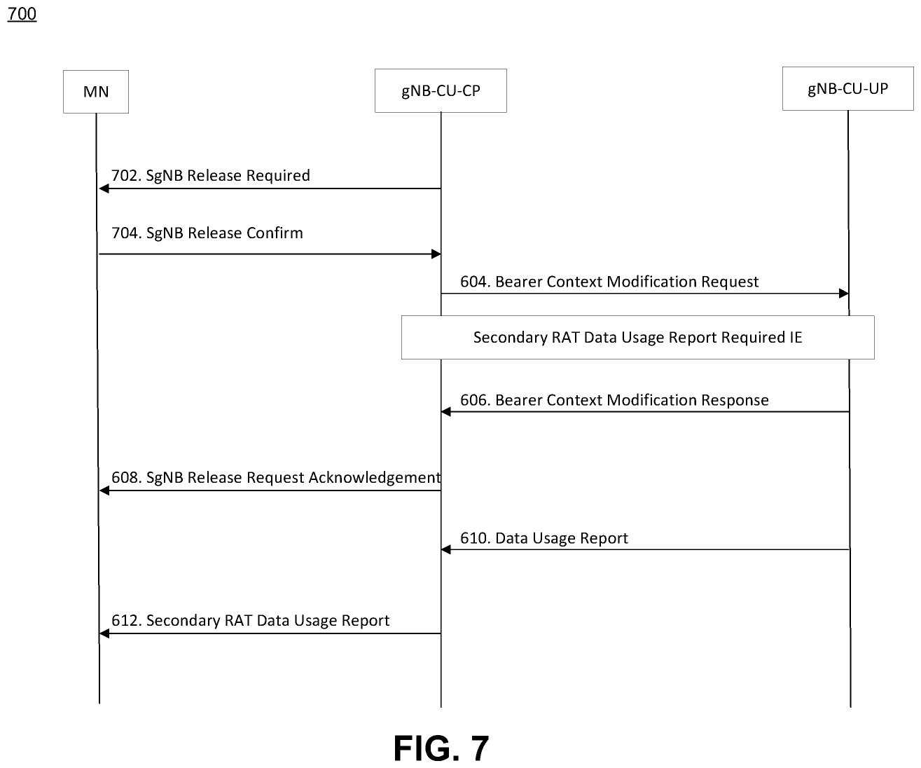

FIG. 7 illustrates an example call flow 700 of a SN initiated release, in accordance with one or more embodiments.

In operation 702, the gNB-CU-CP sends a SgNB release required message to the MN. In operation 704, in response to the SgNB release required message, the MN sends a SgNB release confirm message. Operations 604-612 in FIG. 7 may corresponds to operations 604-612, respectively, in FIG. 6.

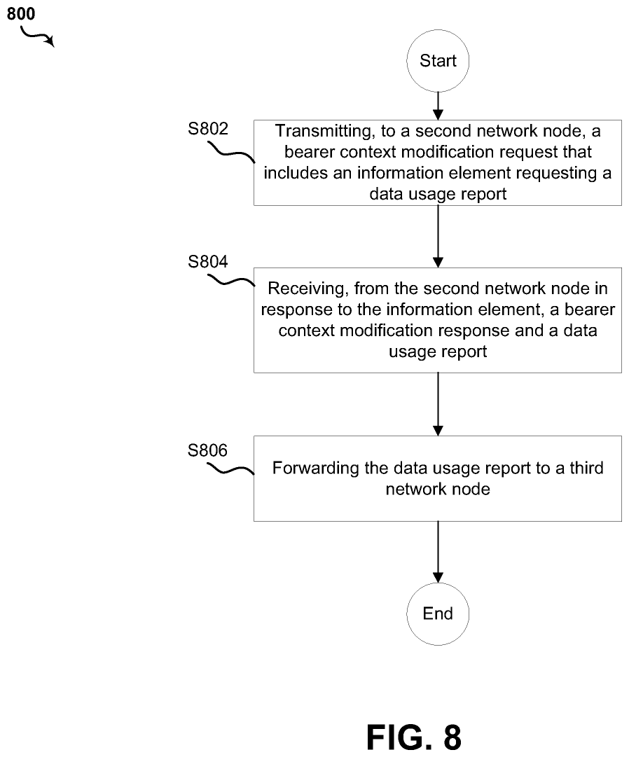

FIG. 8 illustrates an example flowchart of a process 800 for requesting and sending a data usage report, in accordance with various embodiments of the present disclosure. The process 800 may be implemented by a first network node such as the gNB-CU-CP.

The process may start at operation S802 where the first node transmits, to a second network node (e.g., gNB-CU-UP) a bearer context modification request that includes an information element requesting a data usage report. The information element may correspond to the information element in Table 1. The process proceeds to operation S804, where the first network node receives, from the second network node in response to the information element, a bearer context modification response and a data usage report. The process proceeds to operation S806 where the first network node forwards the data usage report to a third network node (e.g., MN). The process illustrated in FIG. 8 may terminate after operation S806 is performed.

The foregoing disclosure provides illustration and description, but is not intended to be exhaustive or to limit the implementations to the precise form disclosed. Modifications and variations are possible in light of the above disclosure or may be acquired from practice of the implementations.

It is understood that the specific order or hierarchy of blocks in the processes/flowcharts disclosed herein is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

The above disclosure also encompasses the embodiments listed below:

(1) A first network node, comprising: at least one memory configured to store computer program code; and at least one processor configured to access said at least one memory and operate as instructed by the computer program code, the computer program code including: first transmitting code configured to cause at least one of said at least one processor to transmit, to a second network node, a bearer context modification request that includes an information element requesting a data usage report, first receiving code configured to cause at least one of said at least one processor to receive, from the second network node in response to the information element included in the bearer context modification request, a bearer context modification response and a data usage report, and forwarding code configured to cause at least one of said at least one processor to the data usage report to a third network node.

(2) The first network node according to feature (1), in which the computer program code further includes: second receiving code configured to cause at least one of said at least one processor to receive, from the third network node, a release request message that causes the first network node to transmit the bearer context modification request to the second network node, and second transmitting code configured to cause at least one of said at least one processor to transmit, to the third network node in response to receiving the bearer context modification response, a release request acknowledgement.

(3) The first network node according to feature (1), in which the computer program code further includes: second transmitting code configured to cause at least one of said at least one processor to transmit, to the third network node, a release required message, and second receiving code configured to cause at least one of said at least one processor to receive, from the third network node in response to the release required message, a release confirm message that causes the first network node to transmit the bearer context modification request to the second network node.

(4) The first network node according to any one of features (1)-(3), in which the first network node is a central unit control plane (CU-CP) network node.

(5) The first network node according to any one of features (1)-(4), in which the second network node is a central unit user plane (CU-UP) network node.

(6) The first network node according to any one of features (1)-(5), in which the third network node is a master node (MN).

(7) The first network node according to any one of features (1)-(6), in which the data usage report is a secondary radio access technology (RAT) usage report.

(8) A method performed by at least one processor of a first network node, the method comprising: transmitting, to a second network node, a bearer context modification request that includes an information element requesting a data usage report; receiving, from the second network node in response to the information element included in the bearer context modification request, a bearer context modification response and a data usage report; and forwarding the data usage report to a third network node.

(9) The method according to feature (8), further comprising: receiving, from the third network node, a release request message that causes the first network node to transmit the bearer context modification request to the second network node; and transmitting, to the third network node in response to receiving the bearer context modification response, a release request acknowledgement.

(10) The method according to feature (8), further comprising: transmitting, to the third network node, a release required message; and receiving, from the third network node in response to the release required message, a release confirm message that causes the first network node to transmit the bearer context modification request to the second network node.

(11) The method according to any one of features (8)-(10), in which the first network node is a central unit control plane (CU-CP) network node.

(12) The method according to any one of features (8)-(11), in which the second network node is a central unit user plane (gNB-CU-UP) network node.

(13) The method according to any one of features (8)-(12), in which the third network node is a master node (MN).

(14) The method according to any one of features (8)-(13), in which the data usage report is a secondary radio access technology (RAT) usage report.

(15) A non-transitory computer readable medium having instructions stored therein, which when executed by a processor of a first network node cause the processor to execute a method comprising: transmitting, to a second network node, a bearer context modification request that includes an information element requesting a data usage report; receiving, from the second network node in response to the information element included in the bearer context modification request, a bearer context modification response and a data usage report; and forwarding the data usage report to a third network node.

(16) The non-transitory computer readable medium according to feature (15), in which the method further comprises: receiving, from the third network node, a release request message that causes the first network node to transmit the bearer context modification request to the second network node; and transmitting, to the third network node in response to receiving the bearer context modification response, a release request acknowledgement.

(17) The non-transitory computer readable medium according to feature (15), further comprising: transmitting, to the third network node, a release required message; and receiving, from the third network node in response to the release required message, a release confirm message that causes the first network node to transmit the bearer context modification request to the second network node.

(18) The non-transitory computer readable medium according to any one of features (15)-(17), in which the first network node is a central unit control plane (gNB-CU-CP) network node.

(19) The non-transitory computer readable medium according to any one of features (15)-(18), in which the second network node is a central unit user plane (gNB-CU-UP) network node.

(20) The non-transitory computer readable medium according to feature 15, in which the third network node is a master node (MN).

```
APPENDIX
PDU Definitions
-- ASN1START
-- ********************************************************
--
-- PDU definitions for E1AP
--
-- ********************************************************
E1AP-PDU-Contents {
itu-t (0) identified-organization (4) etsi (0) mobileDomain (0)
ngran-access (22) modules (3) elap (5) version1 (1) elap-PDU-Contents (1)
}
DEFINITIONS AUTOMATIC TAGS ::=
BEGIN
-- ********************************************************
--
-- IE parameter types from other modules
--
-- ********************************************************
IMPORTS
    Cause,
    CriticalityDiagnostics,
    GNB-CU-CP-UE-E1AP-ID,
    GNB-CU-UP-UE-E1AP-ID,
    UE-associatedLogicalE1-ConnectionItem,
    GNB-CU-UP-ID,
    GNB-CU-UP-Name,
    Extended-GNB-CU-UP-Name,
    GNB-CU-CP-Name,
    Extended-GNB-CU-CP-Name,
    CNSupport,
    PLMN-Identity,
    Slice-Support-List,
    NR-CGI-Support-List,
    QoS-Parameters-Support-List,
    SecurityInformation,
    BitRate,
    BearerContextStatusChange,
    DRB-To-Setup-List-EUTRAN,
    DRB-Setup-List-EUTRAN,
    DRB-Failed-List-EUTRAN,
    DRB-To-Modify-List-EUTRAN,
    DRB-Measurement-Results-Information-List,
    DRB-Modified-List-EUTRAN,
    DRB-Failed-To-Modify-List-EUTRAN,
    DRB-To-Remove-List-EUTRAN,
    DRB-Required-To-Remove-List-EUTRAN,
    DRB-Required-To-Modify-List-EUTRAN,
    DRB-Confirm-Modified-List-EUTRAN,
    DRB-To-Setup-Mod-List-EUTRAN,
    DRB-Setup-Mod-List-EUTRAN,
    DRB-Failed-Mod-List-EUTRAN,
    ExtendedSliceSupportList,
    PDU-Session-Resource-To-Setup-List,
    PDU-Session-Resource-Setup-List,
    PDU-Session-Resource-Failed-List,
    PDU-Session-Resource-To-Modify-List,
    PDU-Session-Resource-Modified-List,
    PDU-Session-Resource-Failed-To-Modify-List,
    PDU-Session-Resource-To-Remove-List,
    PDU-Session-Resource-Required-To-Modify-List,
    PDU-Session-Resource-Confirm-Modified-List,
    PDU-Session-Resource-To-Setup-Mod-List,
    PDU-Session-Resource-Setup-Mod-List,
    PDU-Session-Resource-Failed-Mod-List,
    PDU-Session-To-Notify-List,
    DRB-Status-Item,
    DRB-Activity-Item,
    Data-Usage-Report-List,
    TimeToWait,
    ActivityNotificationLevel,
    ActivityInformation,
    New-UL-TNL-Information-Required,
    GNB-CU-CP-TNLA-Setup-Item,
    GNB-CU-CP-TNLA-Failed-To-Setup-Item,
    GNB-CU-CP-TNLA-To-Add-Item,
    GNB-CU-CP-TNLA-To-Remove-Item,
    GNB-CU-CP-TNLA-To-Update-Item,
    GNB-CU-UP-TNLA-To-Remove-Item,
    TransactionID,
    Inactivity-Timer,
    DRBs-Subject-To-Counter-Check-List-EUTRAN,
    DRBs-Subject-To-Counter-Check-List-NG-RAN,
    PPI,
    GNB-CU-UP-Capacity,
    GNB-CU-UP-OverloadInformation,
    DataDiscardRequired,
    PDU-Session-Resource-Data-Usage-List,
    RANUEID,
    GNB-DU-ID,
    TraceID,
    TraceActivation,
    SubscriberProfileIDforRFP,
    AdditionalRRMPriorityIndex,
    RetainabilityMeasurementsInfo,
    Transport-Layer-Address-Info,
    HW-CapacityIndicator,
    RegistrationRequest,
    ReportCharacteristics,
    ReportingPeriodicity,
    TNL-AvailableCapacityIndicator,
    DLUPTNLAddressToUpdateItem,
    ULUPTNLAddressToUpdateItem,
    NPNContextInfo,
    NPNSupportInfo,
    MDTPLMNList,
    PrivacyIndicator,
    URIaddress,
    DRBs-Subject-To-Early-Forwarding-List,
    CHOInitiation,
    ExtendedSliceSupportList,
    TransportLayerAddress,
    AdditionalHandoverInfo,
    Extended-NR-CGI-Support-List,
    DirectForwardingPathAvailability,
  DataUsageReportRequired
```

What is claimed is:

1. A first network node, comprising:
at least one memory configured to store computer program code; and
at least one processor configured to access said at least one memory and operate as instructed by the computer program code, the computer program code including:
first transmitting code configured to cause at least one of said at least one processor to transmit, to a second network node, a bearer context modification request that includes an information element requesting a data usage report,
first receiving code configured to cause at least one of said at least one processor to receive, from the second network node in response to the information element included in the bearer context modification request, a bearer context modification response and a data usage report, and
forwarding code configured to cause at least one of said at least one processor to the data usage report to a third network node.

2. The first network node according to claim 1, wherein the computer program code further includes:
second receiving code configured to cause at least one of said at least one processor to receive, from the third network node, a release request message that causes the first network node to transmit the bearer context modification request to the second network node, and
second transmitting code configured to cause at least one of said at least one processor to transmit, to the third network node in response to receiving the bearer context modification response, a release request acknowledgement.

3. The first network node according to claim 1, wherein the computer program code further includes:
second transmitting code configured to cause at least one of said at least one processor to transmit, to the third network node, a release required message, and
second receiving code configured to cause at least one of said at least one processor to receive, from the third network node in response to the release required message, a release confirm message that causes the first network node to transmit the bearer context modification request to the second network node.

4. The first network node according to claim 1, wherein the first network node is a central unit control plane (CU-CP) network node.

5. The first network node according to claim 1, wherein the second network node is a central unit user plane (gNB-CU-UP) network node.

6. The first network node according to claim 1, wherein the third network node is a master node (MN).

7. The first network node according to claim 1, wherein the data usage report is a secondary radio access technology (RAT) usage report.

8. A method performed by at least one processor of a first network node, the method comprising:
transmitting, to a second network node, a bearer context modification request that includes an information element requesting a data usage report;
receiving, from the second network node in response to the information element included in the bearer context modification request, a bearer context modification response and a data usage report; and
forwarding the data usage report to a third network node.

9. The method according to claim 8, further comprising:
receiving, from the third network node, a release request message that causes the first network node to transmit the bearer context modification request to the second network node; and
transmitting, to the third network node in response to receiving the bearer context modification response, a release request acknowledgement.

10. The method according to claim 8, further comprising:
transmitting, to the third network node, a release required message; and
receiving, from the third network node in response to the release required message, a release confirm message that causes the first network node to transmit the bearer context modification request to the second network node.

11. The method according to claim 8, wherein the first network node is a central unit control plane (CU-CP) network node.

12. The method according to claim 8, wherein the second network node is a central unit user plane (gNB-CU-UP) network node.

13. The method according to claim 8, wherein the third network node is a master node (MN).

14. The method according to claim 8, wherein the data usage report is a secondary radio access technology (RAT) usage report.

15. A non-transitory computer readable medium having instructions stored therein, which when executed by a processor of a first network node cause the processor to execute a method comprising:
transmitting, to a second network node, a bearer context modification request that includes an information element requesting a data usage report;
receiving, from the second network node in response to the information element included in the bearer context modification request, a bearer context modification response and a data usage report; and
forwarding the data usage report to a third network node.

16. The non-transitory computer readable medium according to claim 15, wherein the method further comprises:
receiving, from the third network node, a release request message that causes the first network node to transmit the bearer context modification request to the second network node; and
transmitting, to the third network node in response to receiving the bearer context modification response, a release request acknowledgement.

17. The non-transitory computer readable medium according to claim 15, further comprising:
transmitting, to the third network node, a release required message; and
receiving, from the third network node in response to the release required message, a release confirm message that causes the first network node to transmit the bearer context modification request to the second network node.

18. The non-transitory computer readable medium according to claim 15, wherein the first network node is a central unit control plane (gNB-CU-CP) network node.

19. The non-transitory computer readable medium according to claim 15, wherein the second network node is a central unit user plane (gNB-CU-UP) network node.

20. The non-transitory computer readable medium according to claim 15, wherein the third network node is a master node (MN).
